(19) United States
(12) Patent Application Publication
(10) Pub. No.: US 2015/0363068 A1
(43) Pub. Date: Dec. 17, 2015

(54) A CONTEXT-SENSITIVE REMOTE CONTROLLER

(71) Applicant: LUKUP MEDIA PRIVATE LIMITED, Karnataka (IN)

(72) Inventor: KALLOL BORAH, BANGALORE (IN)

(73) Assignee: LUKUP MEDIA PRIVATE LIMITED, BANGALORE, KA (IN)

(21) Appl. No.: 14/761,714

(22) PCT Filed: Jan. 20, 2014
(86) PCT No.: PCT/IN2014/000037

§ 371 Date: Jul. 17, 2015

(30) Foreign Application Priority Data
Jan. 22, 2013 (IN) 298/CHE/2013

(51) Int. Cl. G06F 3/0488; H04N 5/445; G06F 1/16; G06F 3/041

(52) U.S. Cl. CPC G06F 3/0488; G06F 3/041; H04N 5/44582; G06F 1/1613

(57) ABSTRACT

A method and system for controlling operations of electronic devices in a context sensitive manner have been provided. The control actions available on a context sensitive, interactive remote controller depend upon the content currently viewed or used on the electronic devices. The interactive remote controller with an in-built display module provides personal control features such as setting up program reminders, receiving and viewing social recommendations, designating favorite shows, and searching and organizing media content. The interactive remote controller is not overloaded with a large set of standard buttons that have selective relevance to the operations performed on electronic devices at a given instance of time. The interactive remote controller ensures that personal activities such as liking a program does not disrupt collective user experience, thereby providing privacy to a user by displaying text inputs, contextual menus, notifications and reminders, on the in-built display module.

### CROSS REFERENCE TO RELATED APPLICATIONS

The present patent application claims the priority of the Indian Provisional Patent Application No. 298/CHE/2013 filed on 22 Jan. 2013. This patent application is a U.S. National Phase Application under 35 U.S.C. 371, of the PCT International Application No. PCT/IN2014/000037 filed on 20 Jan. 2014, and titled “A Context-Sensitive Remote Controller”.

### BACKGROUND

1. Technical Field

The embodiments herein generally relates to presentation of information on a display device and particularly relates to context sensitive control of television and other electronic devices using an interactive remote controller. The embodiments herein more particularly relates to a method for displaying context sensitive control options on an interactive display screen.

2. Description of Related Art

Set top boxes are devices that receive analog/digital content through satellite, cable, terrestrial and internet connections. Set top boxes are capable of tuning into different frequencies to receive the content, decrypting and decoding the content received in multiple formats and the like. Over the time, the functional ability of the set top boxes and digital televisions has increased manifold. New generation set top boxes and digital televisions provide for parallel execution of multiple applications which allow TV viewers to watch their favorite TV shows, share content on social networks, fetch content on demand from sources on the internet, play games, use interactive advertising, store content, set reminders and access subscribed contents received by set top boxes, on other devices such as mobile phones and tablet PCs. Consequently, digital televisions and set top box control units come equipped with sophisticated remote controller systems which include with buttons to control and implement all the aforementioned features.

Given the availability of a plethora of content on digital televisions and set top boxes, and possible interactions also mean that viewers watching TV need to personalize their individual choice and interactions. For example, viewers may wish to receive content recommendations based on a program that they view on TV, or wish to connect their social networking accounts to television sets, so as to be able to share what they view.

While viewers wish to initiate personalized interactions with their respective television sets, they would also wish to manage their privacy in an environment where a television set is collectively viewed by a group of viewers. To summarize, while content and features on digital televisions and set top boxes have expanded, remote controller devices have been overloaded with features and buttons required to control the television and the set top box. Remote controller has also retained standard button based user interfaces which do not provide for much personalized or context sensitive control of TV viewing.

With internet integration, set top boxes have morphed into home gateways that can stream content on multiple other electronic devices such as wireless music systems, home security cameras, second televisions in homes and more. All these electronic devices connected to a single set top box or home gateway need to be operated simultaneously by users.

In view of the foregoing, there is felt a need to provide an interactive remote controller which provides for context-sensitive television viewing experience. There is also felt a need for an interactive remote controller which provides control actions based on the programs currently being viewed on the corresponding television set. There is also felt a need for an interactive remote controller that enables a division between personal and collective viewing thereby offering privacy to a viewer and thus allowing the user to perform personal actions without disrupting other viewers' viewing experience. There is also a need for such an interactive remote controller to enable operation of multiple devices at the same time without interrupting each other's user experience.

The above mentioned shortcomings, disadvantages and problems are addressed herein and which will be understood by reading and studying the following specification.

### OBJECTIVES OF THE EMBODIMENTS

The primary object of the embodiments herein is to provide a context sensitive interactive remote controller.

Another object of the embodiments herein is to provide a remote controller with an interactive display module.

Still a further object of the embodiments herein is to provide a remote controller that display control options that are sensitive to the content being displayed on a television.

One more object of the embodiments herein is to provide a remote controller that displays the control options without disrupting the viewing experience of the television.

Another object of the embodiments herein is to provide a remote controller that enables a user to switch the display of broadcast content from one electronic device to another.

Yet another object of the embodiments herein is to provide a remote controller that is capable of displaying the control options for a plurality of electronic devices, based on the context of operation of the electronic devices.

These and other objects and advantages of the embodiments herein will become readily apparent from the following detailed description taken in conjunction with the accompanying drawings.

### SUMMARY

The embodiments herein disclose a method and system for providing context sensitive control of electronic devices including but not restricted to televisions, music players, set top boxes and the like, wherein the control options available on a remote controller depend upon the activity being performed by the user on the corresponding electronic device. The embodiments herein provide a remote controller with a display module that displays personalized control features, thereby ensuring that activities including but not restricted to liking a television program, browsing the internet, display of text based inputs, contextual menus, notifications and/or reminders, can be directed to the display module of the remote controller, without disrupting the viewing experience of the television or any other remote operated electronic device.

The embodiments herein envisages a context sensitive remote controller configured to control the operations of a centralized server including but not restricted to a set top box or a home gateway and a plurality of electronic devices communicably coupled to the centralized server. The remote controller, in accordance with the various embodiments comprises an analyzer configured to analyze the context of usage of the centralized server and the electronic devices, and generate context information corresponding to the context of usage of the centralized server and the electronic devices.

The remote controller, in accordance with the embodiments herein comprises a processor configured to process the context information, and generate personalized, actionable control options based on the context information. The processor is further configured to dynamically modify the personalized, actionable control options based on the context information.

The remote controller further comprises a display module configured to display the personalized, actionable control options, the control options accessible and operable via the display module without interrupting the viewing of content on the electronic device(s). The display module is configured to display the control options independent of the operational state of the electronic device(s).

According to one embodiment herein, the remote controller is further configured to communicate with the centralized server by transmitting the personalized, actionable control options, the remote controller further configured to instruct the centralized server, via the control options, to initiate selective and simultaneous streaming of electronic content to the plurality of electronic devices, the remote controller still further configured to manage the streaming of the electronic content on the plurality of electronic devices via the control options.

According to one embodiment herein, the remote controller is configured to receive information relevant to the context of usage of the electronic device(s), from the centralized server. The remote controller is further configured to initiate simultaneous display of received information on the display module, along with the display of the personalized, actionable control options.

According to one embodiment herein, the display module is a touch sensitive display module configured to detect user inputs provided in the form of gestures, wherein the gestures constitute a command. The display module is still further configured to cooperate with the processor to provide for conversion of the gestures into electronic control options, and implementation of the electronic control options.

According to one embodiment herein, the analyzer is configured to analyze the context of usage of centralized server and the electronic devices and generate context information, the context information selected from the group consisting of information related to the content being played on the electronic device(s), information related to the current state of the electronic device(s), and information related to the inputs provided in the form of gestures via the display module.

According to one embodiment herein, the analyzer is configured to generate context information corresponding to the context of usage of each of the electronic devices communicably coupled to the centralized server. The analyzer is further configured to dynamically modify the context information in response to the changes in the context of usage of the electronic devices.

According to one embodiment herein, the centralized server is configured to receive at least web based content and television signals in a plurality of channels. The centralized server is further configured to communicate with the remote controller and the plurality of electronic devices, via a network connection selected from the group consisting of wireless network connection and wired network connection.

The various embodiments herein envisages a method for controlling the operations of a plurality of electronic device(s) via a context sensitive remote controller. The method, according to various embodiments herein comprises the following computer implemented steps: analyzing the context of usage of the centralized server and the electronic devices; generating context information corresponding to the context of usage of the centralized server and the electronic devices; processing the context information using a processor, and generating personalized, actionable control options based on the context information, the control options responsive to the context of usage of corresponding electronic devices; dynamically modifying the personalized, actionable control options based on the context information; displaying, on a display module of the remote controller, the personalized, actionable control options, without interrupting the viewing of content on the electronic device(s), and independent of the operational state of the electronic device(s); initiating, via the remote controller, selective and simultaneous streaming of electronic content to the plurality of electronic devices; and managing the display of the personalized, actionable control options on the remote controller, based on the context information.

According to one embodiment herein, the step of generating context information corresponding to the context of usage of the centralized server and the electronic devices further includes the step of modifying the context information in response to the changes in the context of usage of the electronic devices.

According to one embodiment herein, the step of generating context information further includes the step of generating context information selected from the group consisting of information related to the content being played on the electronic device(s), information related to the current state of the electronic device(s), and information related to the inputs provided in the form of gestures via the display module.

According to one embodiment herein, the method further includes the step of simultaneously displaying, on the display module of the remote controller, the information relevant to the context of usage of the electronic device(s), the information being received from the centralized server.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a block diagram illustrating the communication between the remote controller and a plurality of electronic devices, according to one embodiment herein;

FIG. 2 is a block diagram illustrating the user interface of the remote controller, according to one embodiment herein;

FIG. 3 is a flow diagram illustrating the sequence of communication between a user and a centralized server, via the remote controller, according to one embodiment herein;

FIG. 4 is a block diagram illustrating the functional modules of the remote controller, according to one embodiment herein;

FIG. 5 is a block diagram illustrating the hardware architecture of the centralized server that enables interactive television viewing, according to one embodiment herein; and

FIG. 6 is a flow diagram illustrating the steps involved in a method for controlling the operations of a plurality of electronic device(s), according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

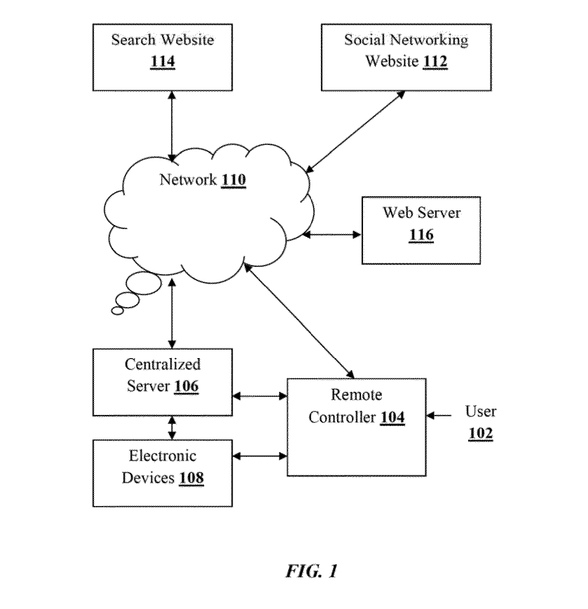

FIG. 1 is a block diagram illustrating the communication between the remote controller and a plurality of electronic devices. The operations of the system and method envisaged by the various embodiments herein have been explained considering a Television only as an example and not as a imitation. The scope of the various embodiments is not restricted to controlling the operations of the television, but includes controlling the operations of electronic devices including but not restricted to music system(s), home security system(s), lighting and heating control system(s), gaming console(s), mobile phone(s), tablet(S) and networked computer(s). FIG. 1 shows a user 102 communicating with a centralized server 106, a television (TV) 108, a social networking website 112, a search engine website 114, a targeted content server 116, through a remote controller 104 having a display 105. The remote controller 104 having a display module 105 provides a personalized and context sensitive TV viewing and control experience. The centralized server 106 is configured to feed both electronic signals and the web based content to the television 108. According to one embodiment herein, the content being transmitted into the centralized server 106 includes but is not restricted to Television signals (analog as well as digital), internet content, streaming media content, games related content, web based applications related content, music related content, and the like. Further, the centralized server 106 is selected from the group consisting of set top boxes, home network hubs, and gateway products. Further, the electronic device 108 is selected from the group consisting of television, music system, car infotainment system, mobile phone, personal computer, tablet PC, laptop computer, and gaming console.

The centralized server 106 comprises instructions that enable a user to perform one or more personal control features such as setting up reminders, receive program related recommendations, setting pre-determined TV shows as favorites, searching for content over the internet and the like.

According to one embodiment herein, the instructions for enabling personalized controls are stored on the Television 108. Alternately, the instructions for enabling personalized controls are stored on the remote controller 104. Alternatively, the instructions for enabling personalized controls can be stored on a database of the centralized server 106 communicably coupled to the Television 108. The centralized server 106 communicates with the remote controller 104 to receive control commands and executes the same. When the user 102 makes use of one or more control options available on the remote controller with display 104 such as liking a TV program, invoking of such control options does not interrupt on the collective viewing of the program running on the television.

The context sensitive menu, textual information, program reminders, and the like, are displayed on the display module 105 of remote controller 104 rather than on the screen of the television 108. The aforementioned information can also be displayed irrespective of the operational condition of the television. For example, when the Television is OFF, one or more notifications and/or reminders set by users are retrieved from the centralized server 106 and displayed on the display module 105 of the remote controller 104. Further, a division between personal and collective viewing (e.g., one on remote controller 104, another on the Television 108) can achieved by the way of displaying a particular program on the television 108, and simultaneously displaying the context sensitive menu corresponding to the program being run on the television, on the display module 105 of the remote controller 104. The information displayed on the display module 105 of the remote controller 104 is typically received from the centralized server 106 or from a network server being a part of a cloud computing environment or from any data store.

The contextual menu, which is viewed on the display module 105 of the remote controller 104, is dependent on what is being played on the Television 108. For example, when a particular movie is being played on the Television 108, the contextual menu displayed on the display module 105 includes control options for viewers to like the movie and/or record the movie. On the other hand, if a viewer is searching for a specific program on the Electronic Program Guide (EPG) which is scheduled for telecast at a later time/date, the contextual menu includes control options that enable a user to set a reminder for that particular show. In this case the control option for liking the program would not be displayed since the viewer logically cannot like something that has not been viewed before. In another example, where a viewer views the main program guide and selects a genre like ‘movies’, control options enabling the user search for and/or recommend a movie would be displayed on the display module 105 of the remote controller 104.

The display module 105 of the remote controller 104 enables a user to access features including but not restricted to recommendations corresponding to Television shows and stored media clips, based on user identity. The centralized server 106 is configured to access the World Wide Web by connecting to a modem (e.g., Wifi modem or a wireless modem, modem connected to a Local Area Network, and the like). According to one embodiment herein, the Television 108 or the centralized server 106 comprises an in-built modem capable of providing the user 102 with access to internet on the display module 105 of the remote controller 104 without disrupting the viewing experience of the viewer viewing the television programs on the television 108. The targeted content server 116 pushes the targeted ads, media clips, games, and/or offers to the TV 108, via the centralized server 106, based on user behavior and preferences which are extracted from the remote controller 104.

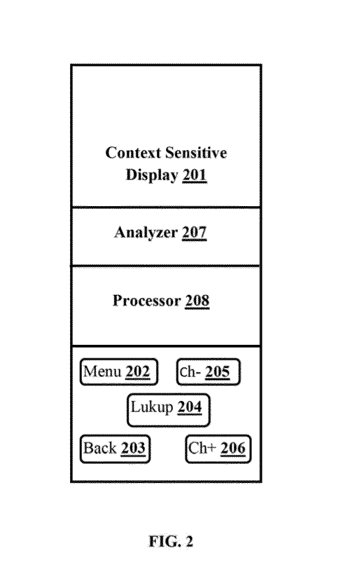

FIG. 2 is a block diagram illustrating the functional components of the interactive remote controller 200, according to one embodiment herein. The interactive remote controller 200 herein is a touch based remote controller with a context sensitive display 201 which displays a context sensitive menu with controls options for controlling the display parameters of a television. The control options included in the context sensitive menu are based on what the user is viewing on TV at that particular instance of time. The other buttons on the remote are standardized buttons including a button 202 for viewing the contextual menu on the display screen 201, a button 203 for going back to previous display on the remote controller 200, a button 204 to search for content, and buttons 205 and 206 for navigating to the next channel and the previous channel respectively. The interactive remote controller 200 allows personalized control of TV and context sensitive viewing of TV and reduces the number of buttons required to control TV viewing at any point of time.

According to one embodiment herein, the interactive remote controller 200 comprises an analyzer 207 configured to analyze the context of usage of the centralized server (denoted by reference numeral 106 in FIG. 1) and the electronic devices (including the Television 108 shown in FIG. 1), and generate context information corresponding to the context of usage of the centralized server 106 and the electronic devices 108.

The remote controller 200 further includes a processor 208 cooperating with the analyzer and configured to process the context information, and generate personalized, actionable control options based on the context information. The personalized, actionable control options are displayed on the display module 201 of the remote controller 200. The processor 208, according to one embodiment herein is further configured to dynamically modify the personalized, actionable control options based on the context information corresponding to the context of usage of the electronic devices 108.

According to one embodiment herein, the display module 201 is configured to display the personalized, actionable control options, wherein the control options are accessible and operable via the display module without interrupting the viewing of streamed content on the electronic device(s) 108.

According to one embodiment herein, the remote controller 200 is further configured to communicate with the centralized server 106 by transmitting the personalized, actionable control options. The remote controller 200 is further configured to instruct the centralized server 106, via the control options, to initiate selective but simultaneous streaming of electronic content to the plurality of electronic devices 108. The remote controller 200 is further configured to manage the streaming of the electronic content on the plurality of electronic devices 108 via the control options.

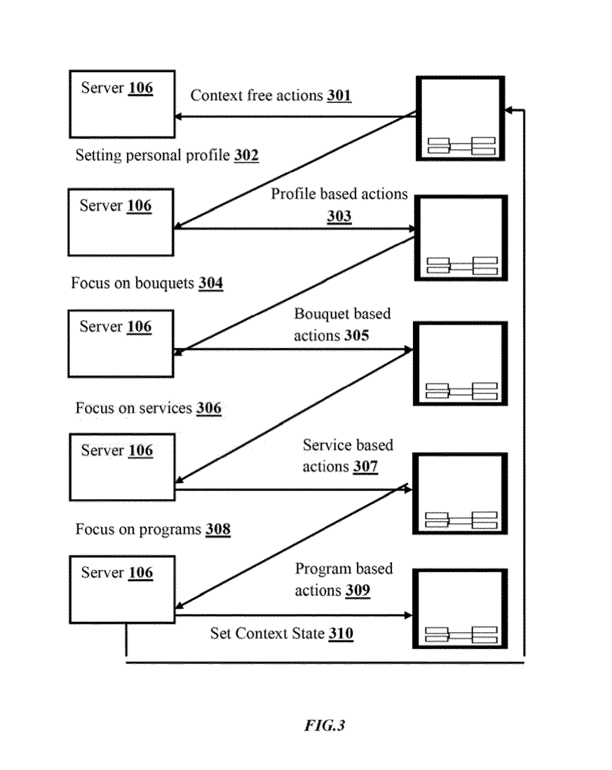

FIG. 3 is a flow diagram illustrating a sequence of a user communicating with a centralized server (106 in FIG. 1) using an interactive remote controller (104 in FIG. 1), according to one embodiment herein. The interactive remote controller 104 displays a personalized menu that is sensitive to what the user is viewing on TV connected to the centralized server. FIG. 3 shows a typical sequence of the effect of context of the TV display on the control actions available on the remote controller 104. In this case some of the available control options are context free 301. This means that the user can execute such control actions irrespective of the state in which the TV display is in at that point in time. The context free actions comprise changing channels, increasing and reducing volume, searching for content, navigating between screens and the like. The plurality of actions such as profile based actions 303, bouquet based actions 305, service based actions 307 and program based actions 309 are context sensitive such that these actions are available on the remote controller based only on the state of the TV display.

The context sensitive actions is also associated to personal profiles 302 created on the centralized server. The personal profiles 302 are created to personalize the experience that users get while watching a television program. The personalized experiences include sharing TV programs and services on social media or getting recommendations based on a user's TV viewing history. If a personal profile is created or if the user continues without creating the personal profile, navigating to a TV display state where a content bouquet is highlighted 304 makes certain bouquet based actions 304 available to the user on the remote controller 104. These bouquet based control actions 305 include those required for creating new custom bouquets, deleting existing custom bouquets, renaming bouquets and importing channels into bouquets.

The content bouquets hold content services and if the user focuses on services and TV display's context is set to services 306, then one or more service based control actions 307 are made available on the remote controller 104. Such controls may include actions required to subscribe and unsubscribe to broadcast content services, creation of custom user defined services, social sharing of services, locking and unlocking of services for privacy reasons.

Content services hold content programs and if the user focuses on programs inside a service and the TV display's context is set to programs 308, certain program based control actions 309 are made available on the remote controller. The program based control actions includes actions required to subscribe and unsubscribe to programs that are available on a pay per view basis, social sharing of programs, recording of programs, reminders on programs, viewing program information and importing of programs into custom user defined services.

If the TV display's state is set to bouquet, service or program or any control available in the case that the user is executing, the centralized server sends back the information regarding the television state 310 to the remote controller 104 so that the remote control 104 can display an appropriate set of controls and user interface elements that the user can act upon.

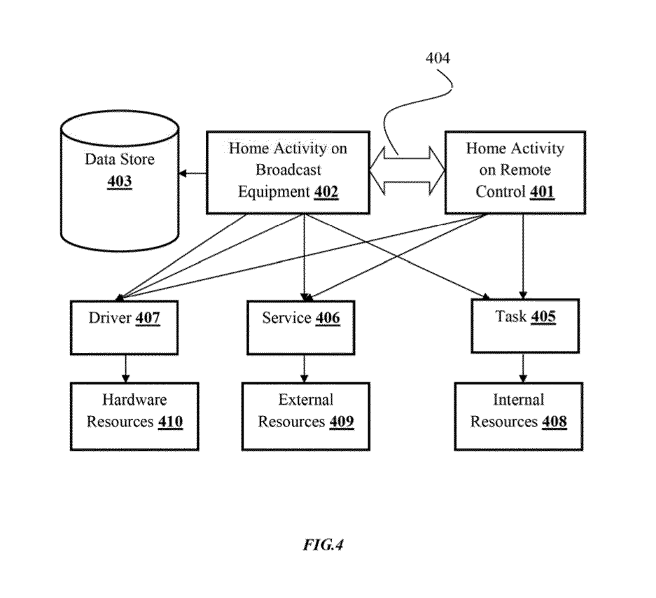

FIG. 4 is a block diagram illustrating the various functional modules on the interactive remote controller and the centralized server that enable context sensitive control of TV, according to one embodiment herein. The software architecture comprises instruction set stored on the remote controller 401, instruction sets executed on the broadcast equipment 402, data stores 403, communication channels 404 between the remote controller 401 and the broadcast equipment 402, short lived application instances called tasks 405 that are executed on the centralized server and the remote controller, long lived application instances called services 406 that are executed on the centralized server, software drivers 407 that help the applications running on the centralized server and the remote controller to communicate with hardware, both internal resources 408 and external resources 409 such as content servers and firmware that configure hardware resources 410 and enable generation of events and data that drivers can capture and pass on to the applications.

The instruction set executed on the remote controller 401 and the broadcast equipment 402 exchange context state information, action commands and data amongst one another. While an application installed in the remote controller 401 captures and sends action commands to an application being executed on the broadcast equipment 402, the broadcast equipment 402 sends back the state of the TV display retained by it to the remote controller 401. On certain commands, the application executed on the broadcast equipment 402 also sends back content and data to the application being executed on remote controller 401 in a format compatible and executable on the remote controller 401, for the purpose of display on the remote controller 401.

The instruction sets executing on the broadcast equipment 402 and the remote controller 401 exchange data, commands and state using communication channel 404 which include wireless signals in one embodiment. The wireless signals can be sent in any number of protocols, both standard and proprietary in nature.

The instruction sets being executed on the broadcast equipment 402 use data store 403 like databases, flat file storage and configuration property stores to retain context state related data. The application executed on broadcast equipment 402 comprises short lived tasks or activities that may run and change internal state of the application. Examples of such short lived tasks include users liking TV programs, or creating new bouquets or importing personal media into them. The application executing on broadcast equipment 402 also includes long running activities called services. Examples of services comprise instances for fetching content, recording content or communicating with a search server to fetch search results. The broadcast equipment 402 also includes libraries to facilitate display of video on TV, fetch personal media from disk drives attached to the centralized server and send communication signals to the remote controller.

In the case of the remote controller 401, the tasks are short lived application instances used to capture and send a command to the broadcast equipment 402 while services comprises long running instances such as listener services that wait and capture any signal sent by the broadcast equipment 402. The drivers for the remote controller include drivers for displaying data on the remote controller display, drivers for capturing inputs and gestures made by users and drivers for sending commands and data to the centralized server using the communication channel 404.

For any change either initiated by the remote controller 401 or the broadcast equipment 402, the change in state is captured by the instruction set of the broadcast equipment 402 and communicated to the remote controller 401 which then displays an appropriate set of control actions to the user.

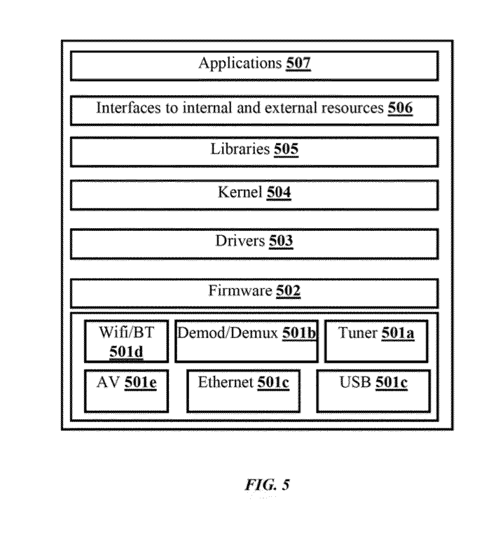

FIG. 5 is a block diagram illustrating the hardware architecture of the centralized server that enables interactive television viewing, according to an embodiment herein. The system stack including both hardware and software components of the centralized server is as shown in FIG. 5. The centralized server comprises hardware components such as tuners 501a to tune into multiple forms of signals such as satellite, cable and terrestrial broadcasts. The centralized server comprises demodulators 501b to extract audio and video from broadcast signals, Ethernet ports 501c and radio frequency components 501d to communicate two-way on a wireless or a wired medium and audio video components 501e to display video and play audio of both standard and high definition formats. The various hardware components are configured with pieces of software called firmware 502 that helps in generating interrupts or signals based on when the hardware components function in a known way. The generated interrupts from hardware components are captured by software drivers 503 that are subsequently fed into the operating system kernel 504. The kernel 504 is accessed by several libraries 505 which are the part of a virtual machine or implemented by product developers to access custom hardware specific signals and communicate back with hardware components. The libraries are used by applications 507 to run tasks and services and they may use public or external and private or internal interfaces 506 to access resources hosted on the centralized server or hosted externally by a third party system. Here the internal resources are databases and external resources are content serving servers.

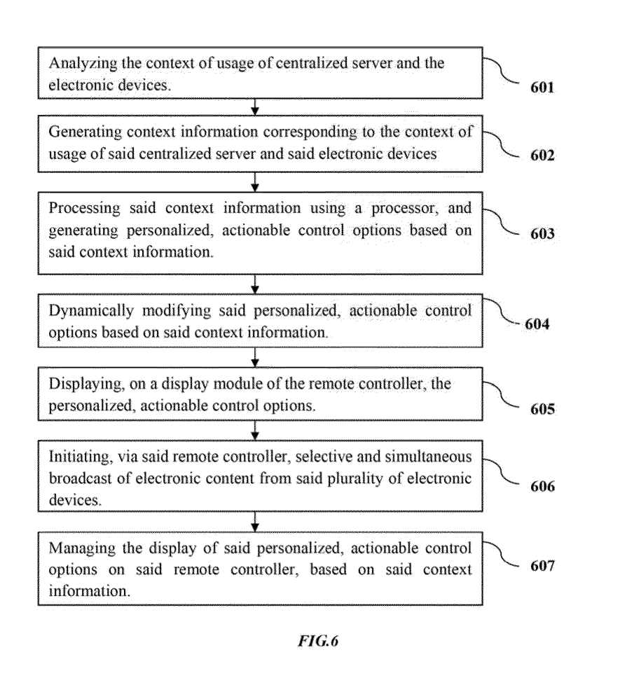

FIG. 6 is a flow diagram illustrating the steps involved in a method for controlling the operations of a plurality of electronic device(s), according to one embodiment herein. According to one embodiment herein, the method comprises the following steps:
analyzing the context of usage of the centralized server and the electronic devices 601;
generating context information corresponding to the context of usage of the centralized server and the electronic devices 602;
processing the context information using a processor, and generating personalized, actionable control options based on the context information, the control options responsive to the context of usage of corresponding electronic devices 603;
dynamically modifying the personalized, actionable control options based on the context information 604;
displaying, on a display module of the remote controller, the personalized, actionable control options, without interrupting the viewing of streamed content on the electronic device(s), and independent of the operational state of the electronic device(s) 605;
initiating, via the remote controller, selective and simultaneous streaming of electronic content to the plurality of electronic devices 606; and
managing the display of the personalized, actionable control options on the remote controller, based on the context information 607.

According to one embodiment herein, the step of generating context information corresponding to the context of usage of the centralized server and the electronic devices further includes the step of modifying the context information in response to the changes in the context of usage of the electronic devices.

According to one embodiment herein, the step of generating context information further includes the step of generating context information selected from the group consisting of information related to the streamed content being played on the electronic device(s), information related to the current state of the electronic device(s), and information related to the inputs provided in the form of gestures via the display module.

According to one embodiment herein, the method further includes the step of simultaneously displaying, on the display module of the remote controller, the information relevant to the context of usage of the electronic device(s), the information being received from the centralized server.

The technical advantages envisaged by the various embodiments herein include the realization of a context-sensitive remote controller comprising a built in display module. The display module of the remote controller in interactive in terms of the functionalities. The display module interacts with a user of an electronic device, and provides the user with context-sensitive control options for managing the functioning of the electronic device. In case of a television, the context-sensitive remote controller displays only those control options that are relevant to the media content being viewed on the television. The context sensitive remote controller displays the control options without disrupting the collective television viewing experience. Further, the context sensitive remote controller envisaged by the various embodiments herein is capable of displaying context sensitive control options for a plurality of electronic devices operable via the context sensitive remote controller.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A context sensitive remote controller configured to control the operations of a centralized server and a plurality of electronic devices communicably coupled to said centralized server, said remote controller comprising:
an analyzer configured to analyze the context of usage of the centralized server and said electronic devices, and generate context information corresponding to the context of usage of said centralized server and said electronic devices;
a processor cooperating with said analyzer, said processor configured to process said context information, and generate personalized, actionable control options based on said context information, said processor further configured to dynamically modify said personalized, actionable control options based on said context information;
a display module cooperating with said processor and configured to display said personalized, actionable control options, said control options accessible and operable via said display module without interrupting the viewing and experience of content on said electronic device(s), said display module still further configured to display said control options independent of the operational state of said electronic device(s);
said remote controller further configured to communicate with said centralized server by transmitting said personalized, actionable control options, said remote controller further configured to instruct said centralized server, via said control options, to initiate selective and simultaneous streaming of electronic content to said plurality of electronic devices, said remote controller still further configured to manage the streaming of the electronic content on said plurality of electronic devices via said control options.

2. The system as claimed in claim 1, wherein said remote controller is configured to receive information relevant to the context of usage of said electronic device(s), from said centralized server, said remote controller further configured to initiate simultaneous display of received information on said display module, along with the display of said personalized, actionable control options.

3. The system as claimed in claim 1, wherein said display module is a touch sensitive display module configured to detect user inputs provided in the form of gestures, wherein said gestures constitute a command, said display module still further configured to cooperate with said processor to provide for conversion of said gestures into electronic control options, and implementation of the electronic control options.

4. The system as claimed in claim 1, wherein said analyzer is configured to analyze the context of usage of centralized server and said electronic devices and generate context information, said context information selected from the group consisting of information related to the content being played or selected on the electronic device(s), information related to the current state of the electronic device(s), and information related to the inputs provided in the form of gestures via said display module.

5. The system as claimed in claim 1, wherein said analyzer is configured to generate context information corresponding to the context of usage of each of the electronic devices communicably coupled to said centralized server, said analyzer further configured to dynamically modify the context information in response to the changes in the context of usage of said electronic devices.

6. The system as claimed in claim 1, wherein said centralized server is configured to receive at least web based content and television signals in a plurality of channels, said centralized server further configured to communicate with the remote controller and the plurality of electronic devices, via a network connection selected form the group consisting of wireless network connection and wired network connection.

7. The system as claimed in claim 1, wherein said centralized server includes at least one of a set top box, a media player, a home gateway and wherein said electronic devices include at least one of a television(s), music system(s), home security system(s), lighting and heating control system(s), gaming console(s), mobile phone(s), tablet(S) and networked computer(s).

8. A method for controlling the operations of a plurality of electronic device(s) via a context sensitive remote controller, said method comprising the following steps:
analyzing the context of usage of the centralized server and said electronic devices;
generating context information corresponding to the context of usage of said centralized server and said electronic devices;
processing said context information using a processor, and generating personalized, actionable control options based on said context information, said control options responsive to the context of usage of corresponding electronic devices;
dynamically modifying said personalized, actionable control options based on said context information;
displaying, on a display module of the remote controller, the personalized, actionable control options, without interrupting the viewing of content on said electronic device(s), and independent of the operational state of said electronic device(s);
initiating, via said remote controller, selective and simultaneous streaming of electronic content to and from said plurality of electronic devices; and
managing the display of said personalized, actionable control options on said remote controller, based on said context information.

9. The method as claimed in claim 8, wherein the step of generating context information corresponding to the context of usage of said centralized server and said electronic devices further includes the step of modifying the context information in response to the changes in the context of usage of said electronic devices.

10. The method as claimed in claim 8, wherein the step of generating context information further includes the step of generating context information selected from the group consisting of information related to the content being played or selected on the electronic device(s), information related to the current state of the electronic device(s), and information related to the inputs provided in the form of gestures via said display module.

11. The method as claimed in claim 8, wherein the method further includes the step of simultaneously displaying, on the display module of the remote controller, the information relevant to the context of usage of said electronic device(s), said information being received from said centralized server.
